(19) United States
(12) Patent Application Publication
(10) Pub. No.: US 2013/0114916 A1
(43) Pub. Date: May 9, 2013

(54) Visually distinct sorting assembly with separable means

(71) Applicant: Brandon P. Gray, Kansas City, MO (US)

(72) Inventor: Brandon P. Gray, Kansas City, MO (US)

(21) Appl. No.: 13/373,262

(22) Filed: Nov. 9, 2011

(51) Int. Cl. B65F 1/06; B65D 33/16; B65D 33/08; B65D 21/00

(52) U.S. Cl. 383/37; 220/23.4; 383/61.4; 383/10

(57) ABSTRACT

The present invention relates generally to an assembly for sorting two or more items. Specifically, the present invention is directed to a sorting assembly having two or more visually distinct compartments joined by a releasably adhesive means that allows for sorting of the two or more items.

### BACKGROUND OF THE INVENTION

1. Field of the Invention

The present invention relates generally to an assembly for sorting two or more items. Specifically, the present invention is directed to a sorting assembly having two or more visually distinct compartments joined by a releasably adhesive means that allows for sorting of the two or more items.

2. Description of Related Art

Efforts have been made in the past to accommodate the increasing need to collect and contain both refuse that is to be disposed as trash and recyclable items that would preferably be kept out of landfills. The consumption of goods and materials in the home or business generates a significant quantity of both recyclable material and non-recyclable refuse. Efforts in the past to provide for the collection and containment of all of these materials has been directed to the use of separate rigid-walled containers that may or may not be intended for use with plastic liners (bags). Rigid-walled recycling containers have been created, some of which are intended for use singly or in multiple units, stacked or otherwise connected for the purpose of retaining recyclable materials either non-separately for single-stream recycling or separately for multiple-stream recycling. These rigid-walled recycling containers may or may not be intended for use with plastic liners. In almost every instance, however, the recycling container designs are intended to replace the standard trash can or to be used in addition to the standard trash can. In either case, the consumer must utilize more than one rigid-walled container to sort recyclable materials separately from refuse. Additionally, availability or space constraints typically prevent the placement of both a refuse rigid-walled container and a recyclable rigid-walled container in each desired location within the home or office.

Efforts have been made to create multi-compartment bags to allow for the separation of refuse from recyclables. These efforts, however, require the bags to be utilized in side-by-side containers or in containers with multiple rigid-walled compartments, but this typically results in the requirement that the consumer purchase either a special rigid-walled trash receptacle or a second rigid-walled receptacle to use these multi-compartment bags and are therefore less desirable for use in standard, commonplace rigid-walled trash receptacles.

Efforts have been made to create bags with multiple compartments by sealing and perforating one larger bag in the longitudinal or horizontal direction so that the perforation will allow the single bag to be separated into two or more individual bags to allow for disposal of refuse material separately from recyclable material. However, this method of manufacture requires more specialized production methods which increase the bag cost. Additionally, this method of manufacture requires the perforated bag to be manufactured from one single color of plastic material, which prevents easy visual identification of which compartment contains refuse, and which contains recyclables.

It would be desirable, therefore, if a product were available that solved the problem of simultaneously collecting and retaining refuse and recyclables without the need to purchase a specialized rigid-walled container or an additional rigid-walled container, which may not always fit in the space available in the home or business environment.

It would be further desirable if a product was available that allowed for easy visual identification of which compartment contains refuse, and which contains recyclables by producing two or more differently colored bags and joining them together with an adhesive that would allow for separation without tearing or damaging either bag after refuse or recyclable material has been placed inside each respective bag. Said visual differentiation could also be achieved with printing an ink onto the plastic material substrate or use of labels placed onto the material substrate. Any of these methods of visual identification of each compartment or bag for proper placement of refuse or recyclables, and then easy separation of said compartments, or bags, would be most desirable.

### SUMMARY OF THE INVENTION

It is therefore an object of the present invention to provide a product that allows for the separate collection and retention of items. It is an object of the present invention to provide a product that allows for the separate collection and retention of both refuse for permanent disposal and recyclable materials for recycling. It is an object of the present invention to provide a product that can be used in conjunction with existing common-sized, single-compartment rigid-walled trash and refuse containers, eliminating the need for the consumer to purchase a specialized rigid-walled container or additional rigid-walled containers and further eliminating the need to find additional space within the home or office to place the additional container or containers.

In one embodiment, the present invention is directed to a sorting assembly comprising two or more visually distinct compartments, and an adhering means, wherein the two or more visually distinct compartments are releasably attached by the adhering means to at least one of the other visually distinct compartments. The two or more visually distinct compartments may include bags having a closed bottom and open top. In addition, the internal compartment volume for the two or more visually distinct compartments may be designed to be approximately equal for all compartments, or may differ from one another. Furthermore, the adhering means generally comprises an adhesive including, but not limited to: N-vinylpyrrolidinone polymer, sucrose, polyethylene glycol, sodium stearate, sodium hydroxide, poly (vinyl alcohol), acrylic polymer, acrylic resin, polyoxyethylene monooctylphenyl ether, 2-aminoisobutanol, 1-methoxy-2-propanol, 3M™ adhesives, 3M™ Scotch adhesives, 3M™ Scotch glue stick adhesives, 3M™ contact adhesives, 3M™ rubber adhesives, 3M™ rubber and vinyl adhesives, 3M™ pressure sensitive adhesives, 3M™ high tack adhesives, 3M™ 76 high tack adhesives, releasable adhesives, 3M™ releasable adhesives, pressure sensitive adhesives, 3M™ pressure sensitive adhesives, releasable pressure sensitive adhesives, or 3M™ releasable pressure sensitive adhesives. Moreover, the two or more visually distinct compartments may include distinct colors, tactile feel, texture, labels, or printing. Furthermore, the two or more visually distinct compartments may generally be constructed with a material including but not limited to: polyethylene, polyvinyl chloride, thermoplastic starch, cellulose-based plastic, aliphatic polyester, polyamide, or polyatic acid derived plastic. Furthermore, the sorting assembly may include a closure means located at the top of the two or more visually distinct compartments designed to seal. Furthermore, the sorting assembly wherein the closure means comprises a drawstring disposed within a channel and an adhesive strip. Furthermore, the sorting assembly may include two or more visually distinct compartments having two or more handle apertures located near the open top.

It is a further object of the present invention to provide a product that can be manufactured using conventional, inexpensive manufacturing methods which include, but are not limited to, the extrusion of plastic bags. It is an object of the present invention to provide a product that can itself be either disposed in a landfill or recycled with other recyclable material it contains after use. It is an object of the present invention to provide a product that that can be dispensed one at a time for use in existing single-compartment rigid-walled trash receptacles. Furthermore it is an object of the present invention to provide a product that can be placed easily in existing single-compartment rigid-walled trash receptacles, and is easy to remove, securely closed using any conventional means, and separable for separately appropriate refuse disposal and recycling, respectively.

### BRIEF DESCRIPTION OF THE DRAWINGS

In the Drawing Figures attached the various components, areas, and/or features of the present invention are labeled and referenced with the following consistent reference numbers, wherein the same reference numbers refer to the same or similar components, areas, and/or features on each of the Drawing Figures.

FIG. 1 is a perspective view of several visually distinctive compartments adhered releasably together of the present invention and configured in a form as it may be removed from a roll or other packaging and ready for placement into a single-compartment rigid-walled trash receptacle.

FIG. 2 is a partial cut away side plan view of the compartments of the present invention in FIG. 1 as they may be placed into a single-compartment, rigid-walled trash receptacle for use. The single-compartment rigid-walled trash receptacle is cut away for clarity to view the compartments of the present invention. FIG. 2 illustrates one possible location for the adhesive of the present invention to releasably hold the compartments together for use in a single-compartment, rigid-walled trash receptacle.

FIG. 3 is a side plan view of the several visually distinctive compartments of the present invention configured after being filled with items (shown with hidden lines) enclosed within one compartment and differing items (shown with hidden lines) enclosed within a different compartment. FIG. 3 illustrates the releasability of the adhesive and visually distinctive nature of the compartments of the present invention as the several compartments are being pulled apart, in one instance, from the top (the side of the compartment(s) with an opening) after filled with items.

FIG. 4 is a side plan view of the several visually distinctive compartments of the present invention configured after being filled with items (shown with hidden lines) enclosed within one compartment and differing items (shown with hidden lines) enclosed within a different compartment. FIG. 4 illustrates the releasability of the adhesive and visually distinctive nature of the compartments of the present invention after the several compartments have been completely separated.

### DETAILED DESCRIPTION OF THE PREFERRED EMBODIMENTS OF THE INVENTION

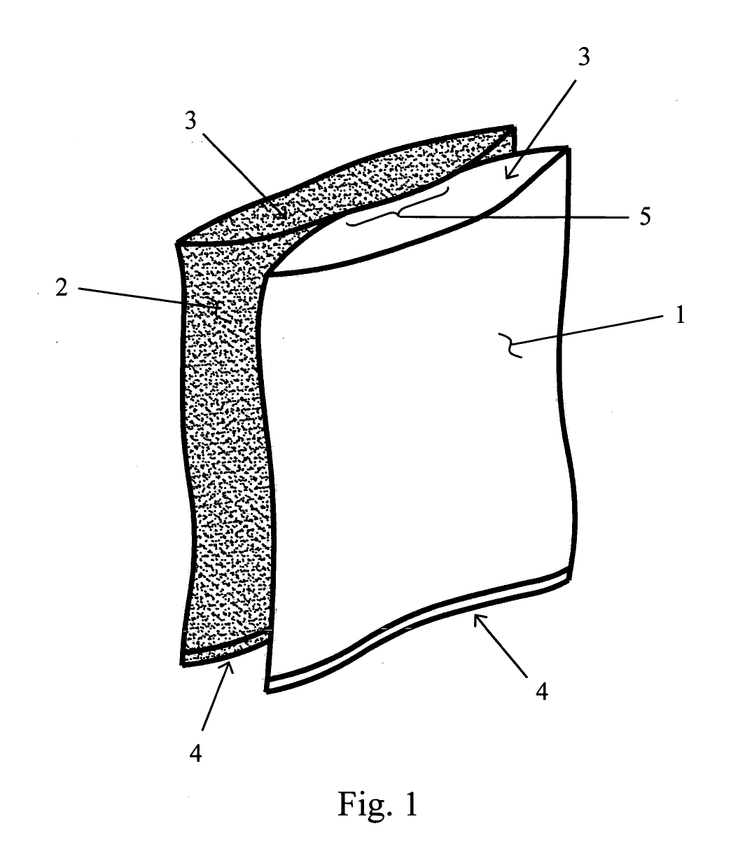

Preferred embodiments of the present invention will be described first in relation to FIG. 1 of the basic combination of the several compartments (1 and 2) and adhesion area 5 thereof of the present invention. FIG. 1 is a perspective view of the present invention as it may have been removed from a roll or other packaging and prepared for use in a single-compartment, rigid-walled trash receptacle (i.e. waste bucket or trash can as may be found in a home or office). Each compartment (1 and 2) is a plastic-film bag constructed from a polymer material similar to a standard trash bag. Materials for constructing the compartments (1 and 2) include, but are not limited to: polyethylene, polyvinyl chloride, thermoplastic starch, cellulose-based plastic, aliphatic polyester, polyamide, or polyatic acid derived plastic.

The top or opening 3 of each compartment (1 and 2) is illustrated along with the bottom 4. or sealed end of each compartment (1 and 2). The sides connecting the opening 3 and bottom 4 may be constructed by folding the compartment (1 and 2) material upon itself or by heat sealing the material together to form each compartment (1 and 2). The bottom 4 of the compartments (1 and 2) may be constructed by folding the compartment (1 and 2) material upon itself or by heat sealing the material together to form each compartment (1 and 2). The internal compartment (1 and 2) volume for the two or more visually distinct compartments (1 and 2) can be approximately equal or different for all compartments (1 and 2). The compartments (1 and 2) are generally rectangular in shape, but may be square, round, or polygonal in shape. The height of the compartments (1 and 2), which is defined as the distance between the opening 3 and the bottom 4, is generally longer than the width, but may be equal or shorter in length than the width. The opening 3 of each visually distinct compartment (1 and 2) may have a means of closure near the top of each compartment (1 and 2) to secure the items in the sorting assembly. The closure means having a drawstring within a channel and an adhesive strip. The opening 3 of each visually distinct compartment (1 and 2) may comprise two or more handle apertures located near the top of the compartments (1 and 2).

In the preferred embodiment shown, each of the several compartments (1 and 2) are differently unique in visual color. The two or more visually distinct compartments (1 and 2) can achieve visual distinction by means of the use of: distinct colors, different tactile feel, different texture, different labels, the inclusion of one or more labels, or the inclusion of printing an ink onto one or more compartments (1 and 2). Different colors may be achieved by including or not including different pigments in the manufacturing process of the compartment (1 and 2) material. Different tactile feel may be achieved by using different materials for the two or more compartments (1 and 2). Different tactile feel may be achieved by using differing thicknesses of material for the compartments (1 and 2). Unique visual distinction of the two or more compartments (1 and 2) may be achieved by including a printed ink on the material of one or more of the compartments (1 and 2) that is different in visual nature from printing on one or more of the other compartments (1 and 2), or by including a printed ink on the material of one or more of the compartments (1 and 2) and not including printed ink on the material of the other compartments (1 and 2). The unique visual distinction between and/or among the several compartments (1 and 2) is an advantage of the present invention in that it allows the user to not confuse which compartment (1 and 2) is being used for each item(s), i.e. trash or recyclables.

In the preferred embodiment shown, the several compartments (1 and 2) are releasably adhered along a common side or portion of a common side area 5. Adhesives used for the joining of the several compartments (1 and 2) may include, but are not limited to: n-vinylpyrrolidinone polymer, sucrose, polyethylene glycol, sodium stearate, sodium hydroxide, poly (vinyl alcohol), acrylic polymer, acrylic resin, polyoxyethylene monooctylphenyl ether, 2-aminoisobutanol, 1-methoxy-2-propanol, 3M™ adhesives, 3M™ Scotch™ adhesives, 3M™ Scotch glue stick adhesives, 3M™ contact adhesives, 3M™ rubber adhesives, 3M™ rubber and vinyl adhesives, 3M™ pressure sensitive adhesives, 3M™ high tack adhesives, 3M™ 76 high tack adhesives, releasable adhesives, 3M™ releasable adhesives, pressure sensitive adhesives, 3M™ pressure sensitive adhesives, releasable pressure sensitive adhesives, or 3M™ releasable pressure sensitive adhesives. The adhesive may be applied by a spray-on or contact means or otherwise at any point in the process of manufacturing the compartments (1 and 2) or after the process of manufacturing the individual compartments (1 and 2) as a secondary operation. The adhesion of the several compartments (1 and 2) along a common side or portion of a common side area 5 allows for easy insertion of the several compartments (1 and 2) into a single-compartment rigid-walled receptacle which supports the compartments during sorting. The adhesion of the several compartments (1 and 2) along a common side or portion of a common side area 5 allows for separation of the several compartments (1 and 2) after sorting is complete. Utilizing an adhesive to temporarily join the several compartments (1 and 2) is an advantage of the present invention in that it allows each compartment (1 or 2) to be manufactured from differently colored, textured, or uniquely printed material.

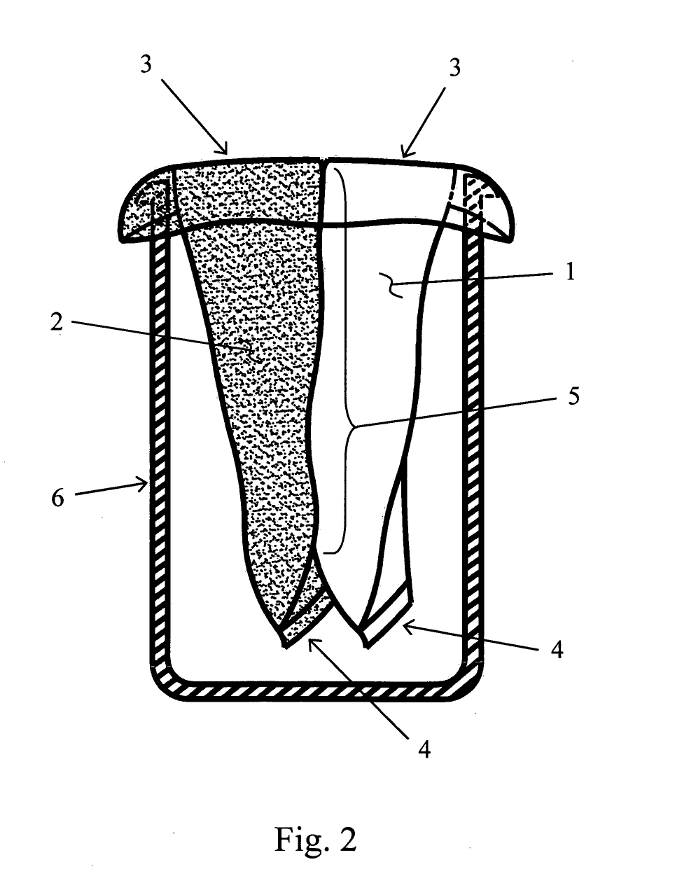

Reference of the preferred embodiments of the present invention is now made in FIG. 2 which illustrates the placement of the compartments (1 and 2) of the present invention into a single-compartment, rigid-walled receptacle 6. FIG. 2 is a partial cut away view wherein the rigid-walled receptacle is shown cut away for clarity. The bottom 4 of the compartments (1 and 2) is toward the bottom of the single-compartment rigid-walled receptacle 6, and the opening 3 of the compartments (1 and 2) is toward the top of the single-compartment, rigid-walled receptacle 6. The opening 3 of the compartments (1 and 2) is placed over the top edge of the single-compartment, rigid-walled receptacle 6 to secure the compartments (1 and 2) in the single-compartment, rigid-walled receptacle 6, and allow the opening 3 of the compartments (1 and 2) to be easily available for the placement of items into the compartments (1 and 2) of the present invention. The height of the several compartments (1 and 2), which is defined as distance between the opening 3 and the bottom 4, is generally long enough to allow a portion of the compartments (1 and 2) to wrap over the top edge of the single-compartment, rigid-walled receptacle 6. Allowing the several compartments (1 and 2) to wrap over the top edge of the single-compartment, rigid-walled receptacle 6 constrains the several compartments (1 and 2) within the single-compartment, rigid-walled receptacle 6 and prevents the several compartments (1 and 2) from falling into the single-compartment, rigid-walled receptacle 6 which would prevent easy access to the opening(s) 3 of the several compartments (1 and 2). In the preferred embodiment shown, each of the several compartments (1 and 2) are differently unique in visual color to aid the user to correctly place the desired items into the respective compartment (1 or 2). In the preferred embodiment shown, the several compartments (1 and 2) are releasably adhered along a common side or portion of a common side area 5.

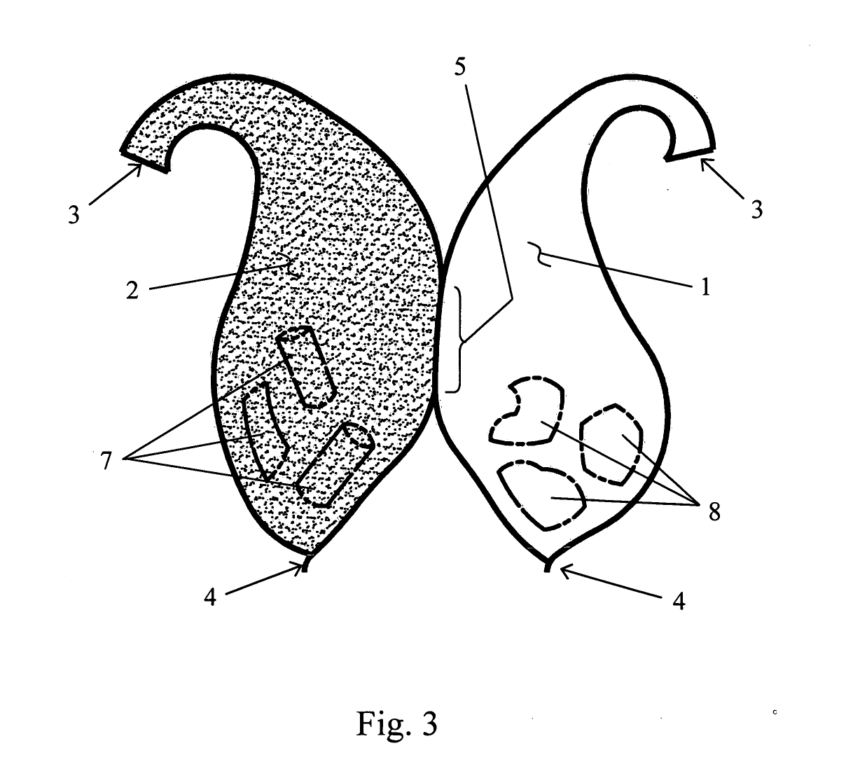

Reference of the preferred embodiments of the present invention is now made in FIG. 3 which illustrates the compartments (1 and 2) of the present invention with items (7 and/or 8) enclosed within each compartment (1 and 2). FIG. 3 illustrates the beginning of the process of separation of the compartments (1 and 2) from each other by the user after such compartments (1 and 2) have collected the desired items (7 and/or 8). In the preferred embodiment shown, each of the several compartments (1 and 2) are differently unique in visual color. In the preferred embodiment shown, the several compartments (1 and 2) are releasably adhered along a common side or portion of a common side 5.

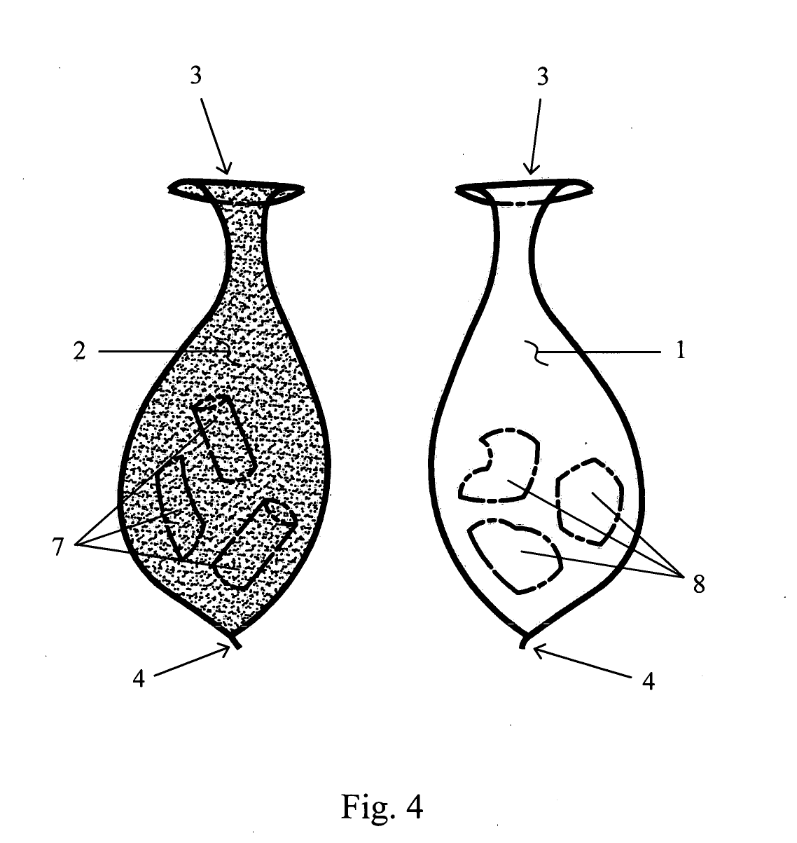

Reference of the preferred embodiments of the present invention is now made in FIG. 4 which illustrates the compartments (1 and 2) of the present invention with items (7 and/or 8) enclosed within each compartment (1 and 2). FIG. 4 illustrates the complete separation of the compartments (1 and 2) from each other by the user after such compartments (1 and 2) have collected the desired items (7 and/or 8). In the preferred embodiment shown, each of the several compartments (1 and 2) are differently unique in visual color to aid the user with correct disposal of each compartment (1 and/or 2), respectively.

1. A sorting assembly comprising two or more visually distinct compartments, wherein said visual distinction is created by differently colored or textured materials of construction or markings on the materials of construction of each compartment, and an adhering means, wherein the two or more visually distinct compartments are releasably attached by the adhering means to at least one of the other visually distinct compartments.

2. The sorting assembly of claim 1, wherein the two or more visually distinct compartments comprise bags having a closed bottom and open top.

3. The sorting assembly of claim 1, wherein the internal compartment volume for the two or more visually distinct compartments is approximately equal for all compartments.

4. The sorting assembly of claim 1, wherein the internal compartment volume for the two or more visually distinct compartments differ from one another.

5. The sorting assembly of claim 1, wherein the adhering means comprises an adhesive.

6. The sorting assembly of claim 5, wherein the adhesive comprises N-vinylpyrrolidinone polymer, sucrose, polyethylene glycol, sodium stearate, sodium hydroxide, poly (vinyl alcohol), acrylic polymer, acrylic resin, polyoxyethylene monooctylphenyl ether, 2-aminoisobutanol, and 1-methoxy-2-propanol, 3M™ adhesives, 3M™ Scotch™ adhesives, 3M™ Scotch™ glue stick adhesives, 3M™ contact adhesives, 3M™ rubber adhesives, 3M™ rubber and vinyl adhesives, 3M™ pressure sensitive adhesives, 3M™ high tack adhesives, 3M™ 76 high tack adhesives, releasable adhesives, 3M™ releasable adhesives, pressure sensitive adhesives, 3M™ pressure sensitive adhesives, releasable pressure sensitive adhesives, or 3M™ releasable pressure sensitive adhesives.

7. The sorting assembly of claim 1, wherein the two or more visually distinct compartments include distinct colors, tactile feel, texture, labels, or printing.

8. The sorting assembly of claim 1, wherein the two or more visually distinct compartments are constructed with a material comprising polyethylene, polyvinyl chloride, thermoplastic starch, cellulose-based plastic, aliphatic polyester, polyamide, or polyatic acid derived plastic.

9-11. (canceled)
